(19) United States
(12) Patent Application Publication
(10) Pub. No.: US 2017/0364948 A1
(43) Pub. Date: Dec. 21, 2017

(54) METHODS, COMPUTER-ACCESSIBLE MEDIUM, AND SYSTEMS TO RANK, CLUSTER, CHARACTERIZE AND CUSTOMIZE USERS, DIGITAL CONTENTS AND ADVERTISEMENT CAMPAIGNS BASED ON IMPLICIT CHARACTERISTIC DETERMINATION

(71) Applicants: GENESIS MEDIA LLC, New York, NY (US); NEW YORK UNIVERSITY, New York, NY (US)

(72) Inventors: Souptik Datta, Cedar Grove, NJ (US); Joshua Feuer, Brooklyn, NY (US); Bhubaneswar Mishra, Great Neck, NY (US)

(21) Appl. No.: 14/854,461

(22) Filed: Sep. 15, 2015

(51) Int. Cl. G06Q 30/02

(52) U.S. Cl. CPC G06Q 30/0255; G06Q 30/0271; G06Q 30/0277

(57) ABSTRACT

The invention provides, in some aspects, a statistical algorithm-driven digital system for automated optimization of a large number of key performance indicators (KPI) involved in social digital interactions among the users, contents and advertisement, further augmented by data-driven verification and recommendation. The users include humans from diverse socio-cultural-economic groups, whose identity may be pseudonymous (though persistent), and whose explicit features may remain private, though statistically imputable. The contents include webpages, downloads, videos, music, or other content accessed by the users. The advertisements include product placement, branding, appeal, surveys, or other third-party contents, not explicit sought by the user. A server application executing on the server digital device responds to requests received from the client digital devices for delivering thereto requested digital content. The server application customizes at least a selected piece of digital content it delivers to a respective client application (in response to such a request) based on ordinal rankings for users, contents and advertisements, computed by a tensor based statistical inference algorithm, as described in a preferred embodiment of this invention. The rankings computed are predictive of various aspects of user's future social interactions, as determined by the past statistical data, summarized in sparse high-dimensional tensors.

### BACKGROUND OF THE INVENTION

The invention relates to customized digital content delivery. The invention relates more particularly, by way of non-limiting example, to the delivery of customized content and advertisements (or other supplemental content) over digital networks. The invention has application, by non-limiting examples, to the improvement of revenue, the size and composition of the user population, quality of contents and advertisements, either individually or in combination.

With one-half billion active web sites and tens of trillions of web pages, the Internet represents a wealth of information of truly epic proportions. And, although the Internet continues to grow, the individual web sites and web pages that make it up are largely static. Not only do most of those sites and pages remain unchanged over time, they typically present the same information to all users who visit them. A user accessing such a page pays the publisher a subscription fee or more often, obtains a free access in exchange for their willingness to be shown an advertisement. Such an event, combining a user, a digital content and an advertisement (or lack of it), can be associated with various measurable social interaction parameters, for example, impediment, session length, abandonment rate, user-loyalty, conversion rate, etc. and are collectively referred as KPI's (key performance indicators).

Apart from news, search and other portals designed around dynamic content, there are few methods to counter the fact that most sites/pages remain unchanged over time, shy of owners making frequent updates to their web sites. As to the fact that most sites deliver the same information to all visitors, efforts have been made to automate the delivery of user-customized content. In order to improve KPI, it is also necessary that a specific user is exposed to advertisements that change over time from one session to the next. In particular, a user may have to be exposed to increasingly more informative advertisements for a product as he navigates among sites and pages that relate to the product. The advertisement may have to be further customized in accordance with the wishes of the advertiser; for instance, a specific advertisement about fashion may only be shown to females in their teens. However, these are typically based on limited and, usually, outdated user profile information that are logged in browser “cookies,” server-side registries and the like. Those approaches, as a practical matter, often result in customizations that add little of value to the user experience and thus fail to improve the KPI's.

A related approach, common on retailing web sites, is to customize individual visitors' experiences by presenting content that has proven of interest to other visitors of like customer profiles. The customizations are typically coarse and the methodologies of limited applicability outside the realm of web retailing. Similar customization of users and advertisements have been contemplated and tried experimentally; for instance the users accessing similar pages and responding well to similar advertisements may be offered free subscription or coupons with a discounted price for a product.

The current invention is related to U.S. patent application Ser. No. 14/568,990, filed: Dec. 12, 2014, entitled, DIGITAL CONTENT DELIVERY BASED ON MEASURES OF CONTENT APPEAL AND USER MOTIVATION, the teachings of which are incorporated herein by reference. Described in that patent application are improved systems and methods in which web pages and/or other pieces of digital content are customized as a function of content appeal rank (CAR), an estimate of the motivation and willingness of a given user to engage with a web page or other content piece based on measures of aggregate user motivation vis-à-vis that page/content piece or pieces like it.

What are needed are improvements to the customization of digital content, the betterment of KPI's, the pricing of advertisements (and other supplemental content), identification of potential subscribers among other goals. These, accordingly, are among the objects of the invention.

Related objects are to provide such methods and systems as are applicable to the customization and delivery of content over networks such as, by way of non-limiting example, the Internet.

Still further objects of the invention are to provide such methods and systems as improve the delivery of content, whether by customizing sequences of web pages presented for traversal and/or traversed by users, by customizing content on those pages, customizing downloads from those pages, or otherwise.

Yet still further objects of the invention are to provide such methods and system as permit customization based on characteristics of the digital content to be delivered, optionally, in view of the profile of the user to whom it is to be delivered.

These and other objects of the invention are evident in the drawings and in the discussion that follows.

### SUMMARY OF THE INVENTION

The foregoing are among the objects attained by the invention, which provides, in some aspects, a digital data system for automated customization and delivery of digital content (e.g., requested substantive content combined with or replaced by supplemental content) over a network based on implicit (i.e., predicted or estimated) characteristics of content appeal, supplemental content viewability, user motivation, and so forth (by way of example) as determined from explicit (i.e., measured) characteristics. That substantive content can include web pages, downloads, or other digital content accessed by a client digital data device from a server digital device. Similarly, the supplemental content can include advertisements, surveys and other auxiliary information, and users can include paying subscribers, users visiting from a social network, anonymous visitors or otherwise.

Such a digital data system can comprise a server digital data device that is coupled to a plurality of client digital data devices over a network such as, for example, the Internet. The server digital data device responds to requests received from the client digital data devices (at the behest of their respective users) by delivering requested digital content, e.g., web pages, to them.

The server digital data device customizes at least a selected piece of digital content (e.g., a selected web page) that it delivers to a respective client digital data device (in response to such a request) based on a quantitative rank that is a function of on one or more implicit characteristics of any of (i) the selected piece (or type) of digital content, (ii) supplemental digital content with which that selected piece combined (or by which it can be supplanted) to provide that customization, (iii) the user requesting the selected piece (or type) of digital content, (iv) the digital data device via which the user makes the request, (v) interactions between the user and the selected and/or supplemental content pieces (or others of the same type) and (vi) a combination of one or more of the foregoing. Those implicit characteristics are determined from factorization of a tensor reflecting user interaction data pertaining to any of items (i)-(vi).

Thus, by way of non-limiting example, the implicit characteristic(s) upon which the rank is based can reflect the projected or estimated appeal to a particular user requesting a particular content piece of a customized version of it comprising that content piece in combination with a particular piece of supplemental content. And, by way of further example, it can represent the appeal of that customized version to that user in view of the particular device by which he/she has made his/her request (and, therefore, by which he/she is likely to view the customized piece).

And, by way of further example, the implicit characteristic(s) upon which the rank is based can reflect the projected or estimated appeal to a particular user requesting a particular type or piece of content of a customized content piece comprising the requested piece (or a piece of the requested type) in combination with a particular type or piece of supplemental content.

And, by way of a further example, the implicit characteristics upon which the rank is based can reflect the appeal to the particular user requesting the content (via his/her particular client device) of a particular piece (or type) of supplemental content, regardless of whether it is delivered with the requested piece of content.

Related aspects of the invention provide a digital data system, e.g., as described above in which the client digital data devices execute client applications such as web browsers, the server digital data device executes an application such as a web server, and the requested digital content comprises web pages.

Other aspects of the invention provide a digital data system, e.g., as described above, in which the server application customizes pieces of digital content (e.g., web pages) by supplementing them, before delivery, with advertisements, calls to action, appeals or other supplemental content. In related aspects of the invention, the server application maximizes the exposure of supplemental digital content pieces by combining them with pieces of digital content that are of high quantitative rank values (by way of example, combining a digital questionnaire with a digital article about popular celebrities that has proven to be of great interest and, thereby, maximizing the chances that users will respond to the survey).

Still other aspects of the invention provide methods of operating a digital data system or a component thereof (e.g., a server digital data processor) in accord with the operations described above.

Yet still other aspects of the invention provide a server digital data device as described above.

These and other aspects of the invention are evident in the drawings and in the discussion that follows.

### BRIEF DESCRIPTION OF THE ILLUSTRATED EMBODIMENT

A more complete understanding of the invention may be attained by reference to the drawings, in which:

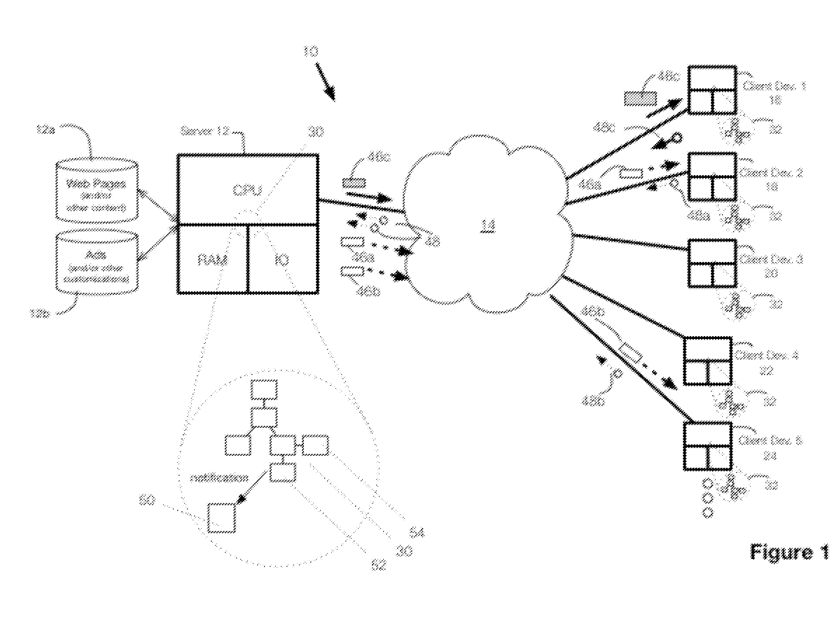

FIG. 1 depicts a digital data processing system according to one practice of the invention for automated customization of content delivered over a network, e.g., the Internet, based on implicit and explicit characteristics (IEC); and

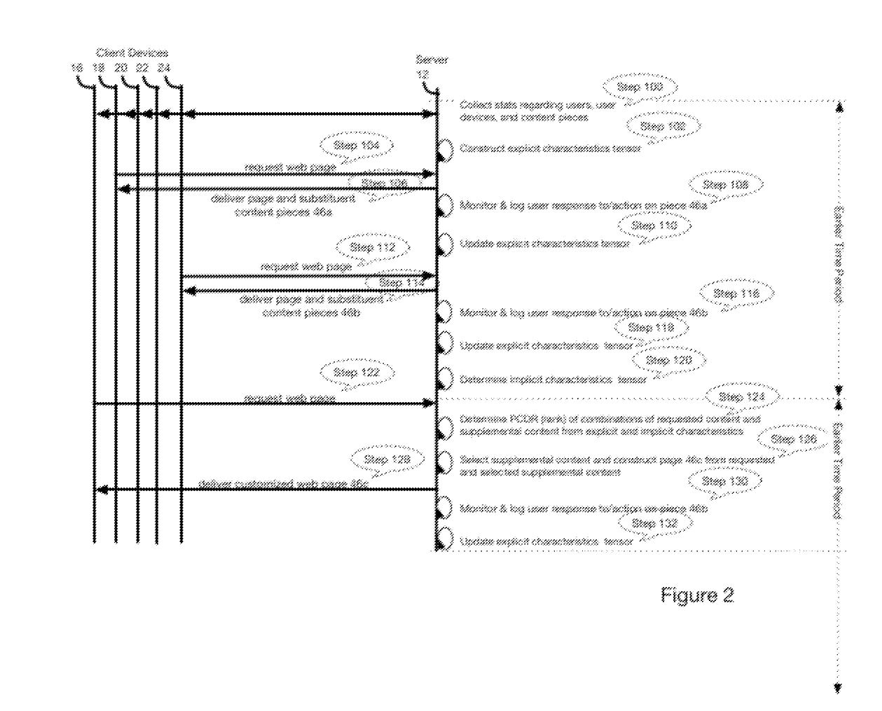

FIG. 2 depicts a time-wise sequence of requests and transfers between a server digital data device and client digital data devices in the system of FIG. 1.

### DETAILED DESCRIPTION OF THE ILLUSTRATED EMBODIMENT

### Overview

FIG. 1 depicts a digital data processing system 10 according to one practice of the invention for automated customization of content delivered over a network, e.g., the Internet. That content can constitute web pages or portions thereof, downloads or portions thereof, or other digital content accessed by a client digital data device from a server digital data device, and its delivery (as that term is used here) refers to transfer and/or presentation of such content. Customization can be via supplemental content that can include advertisements, surveys and other auxiliary information, and users can include paying subscribers, users visiting from a social network, anonymous visitors or otherwise.

Thus, by way of example, according to some practices of the invention, illustrated system 10 can be used for the customization of web pages accessed on a server by a browser executing on a client device. In accord with the embodiments discussed herein, customization can be based, for example, on page-wise measures of (i) content appeal and relevance to the requesting user—that is, measures of content appeal and/or user motivation as measured with respect to prior access to the requested page by other users and/or, potentially, by the same user and (ii) relevance as estimated with respect to response by the requesting user to prior customizations of content presented by the system 10.

Turning to FIG. 1, illustrated system 10 includes a server digital data device 12 that is coupled via network 14 for communication with client digital data devices 16-24. Devices 12 and 16-24 comprise conventional desktop computers, workstations, minicomputers, laptop computers, tablet computers, PDAs or other digital data devices of the type that are commercially available in the marketplace, all as adapted in accord with the teachings hereof. Thus, each comprises central processing (CPU), memory (RAM), and input/output (IO) subsections of the type conventional in the art. The devices 12, 16-24 may be of the same type, though, more typically, they constitute a mix of devices of differing types.

Devices 12 and 16-24—and, more particularly, for example, their respective central processing (CPU), memory (RAM), and input/output (IO) subsections—are configured to execute software applications (depicted, here, by flowchart icons) of the conventional type known in the art, as adapted in accord with the teachings hereof.

Examples of such applications include application 30 executing on device 12 and comprising a web server that responds to requests in HTTP or other protocols for transferring web pages, downloads and other digital content to the requestor over network 14—all in the conventional manner as adapted in accord with the teachings hereof. That digital content may be generated wholly from within application 30, though, more typically, it includes content sourced from elsewhere, e.g., database(s), file systems, or otherwise. Though referred to here as a web server, in other embodiments application 30 may comprise other functionality suitable for responding to client requests for transferring digital content to the requestor over the network 14, e.g., a video server, a music server, or otherwise. And, though discussed here as applications software, in other embodiments application 30 may comprise middleware, operating system or other software, firmware, hardware or other functionality.

A further example of the applications which the aforesaid devices are configured to execute are applications 32 executing on devices 16-24 and comprising web browsers that typically operate under user control to generate requests in HTTP or other protocols for web pages, downloads and other digital content, that transmit to those requests to server application 30 over network 14, and that present content received from the server application 30 to the user—all in the conventional manner as adapted in accord with the teachings hereof. Though referred to here as web browsers, in other embodiments applications 32 may comprise other functionality suitable for transmitting requests to server application 30 and/or presenting content received therefrom in response to those requests, e.g., a video player application, a music player application or otherwise. And, though discussed here as applications software, in other embodiments applications 32 may comprise middleware, operating system or other software, firmware, hardware or other functionality. Illustrated applications 32 may be of the same type as one another, although, in many embodiments, they are of varied types, e.g., a mix of web browsers, music players, video players, etc. And, although in some embodiments the applications 32 may operate in partial cooperation with one another, in the illustrated embodiment they need not.

Although only a single server digital data device 12 is depicted and described here, it will be appreciated that other embodiments may utilize a greater number of these devices, homogeneous, heterogeneous or otherwise, networked or otherwise, to perform the functions ascribed herein to application 30 and/or digital data processor 12. Likewise, although several client digital data devices 16-24 are shown, it will be appreciated that other embodiments may utilize a greater or lesser number of these devices, homogeneous, heterogeneous or otherwise, running applications 32 that are, themselves, as noted above, homogeneous, heterogeneous or otherwise.

Network 14 comprises one or more networks suitable for supporting communications between server 12 and data devices 16-24. The network comprises one or more arrangements of the type known in the art, e.g., local area networks (LANs), wide area networks (WANs), metropolitan area networks (MANs), and or Internet(s).

### Content Customization and Delivery Based on Implicit and Explicit Characteristics

In the illustrated embodiment, application 30 (and, more generally, server 12) customizes each of at least selected web pages it delivers to an application 32 (and, more generally, its respective client device—say, device 16, by way of example) in response to a request made by that application 32 for that web page, e.g., at the behest of its respective user (i.e, the user of device 16, to continue the example). This can be, for example, by incorporation into the web page of an advertisement. The application 30 can, instead or in addition, customize each of at least selected other types of digital content (e.g., music and video downloads, to name a few) delivered to the requesting application 32. And, it can, instead or in addition, perform the customization by inclusion of other types of supplemental content, e.g., surveys, etc. For sake of simplicity, web pages are the type of requested (or “substantive”) digital content and advertisements are the type of supplemental (or auxiliary) digital content discussed in connection with the illustrated embodiment and in the examples that follow. Those skilled in the art will, of course, appreciate that the teachings thereof apply with equal force to other types of requested (substantive) digital content, e.g., music and video downloads to name a few, as well as to other types of supplemental content, e.g., surveys, calls to action, to name a few.

The aforementioned customization of each web page is based on an ordinal rank, referred to here without loss of generality as the “tensor based rank” (or TBR) of that page. In the illustrated embodiment, the TBR is a measure used by application 30 to estimate the utility derived (e.g., motivation and willingness) by the user of a requesting device by engaging with a customized version of that page. Put another way, it serves as an estimate of how much attention a user is likely to pay to a customized version of the web page that she requested and/or how motivated she is to access and stay on that page. The TBR of a given customized page is based on measurements made against the requested page, the supplemental content added to it, the user, and/or his or her client digital data device, as against prior accesses that content by the same or users of other client devices (e.g., devices 18-24 in this example) of the system 10 who share similar characteristics of the requesting user.

In a preferred embodiment, the computed rankings are presented as ordinal rankings and can be expressed as numerical, percentage or ordered (partial or total) rank, but allow, in other non-exemplar embodiments, to be competition, modified competition, dense or fractional rankings. By way of non-limiting examples, multiple rankings may be allowed; rankings may be based on multiple statistics of different aspects of interactions; rankings may be imputed from similarity measures; rankings may be augmented by human experts or be based on heuristics. The rankings and the underlying implicit and explicit characteristics are manipulated to customize the digital contents and advertisements.

And, while in some embodiments, the TBR value can be a measure of aggregate (e.g., network-wide) user motivation and willingness to download, view or otherwise engage with that page, in other embodiments, it may be a measure that is limited to segments of the user population (e.g., users of a given gender or other demographic, users accessing the page at a specific time of day, users accessing the given page from a given site or otherwise). More generally, it can also be a function of the nature or type of impediment and/or of a context in connection with which the user accesses the page or other piece of digital content.

A still further appreciation of the TBR value as employed in some embodiments may be had by reference to the following note:
WHAT IS TENSOR BASED RANK?
A measure of how much attention a user is likely to pay to a webpage customized with or supplanted by supplemental content, such as advertisements, and how much utility is derived by the user when they access the customized page
   Relative to the user, but the measure is an aggregate measure based on all current or potential traffic on that page by users having similar characteristics. Hence it is closer to personalized customization as opposed to generic customization.
   A combined measure of user attributes (or “features”), e.g., motivation and willingness to engage with a piece of requested (substantive), supplemental and/or combined digital content
   The higher the value of TBR, the more valuable is the customized content both from user and content creator (advertiser and publisher) perspective
   Application 30 is in a unique position to learn the features of a requested web page that can be manipulated to improve the ranking, and can be validated or refuted by A/B testing.
TBR INDICATORS (FACTORS)
   Motivation indicators
      When a web page (or other requested piece of content) is commingled with an ad (or other piece of supplemental content), what fraction of visitors respond to the process by skipping the ad, shortening or terminating the session, compared to the fraction that has accessed the page
      An alternative way to measure motivation is to measure how much money users are willing to pay on average when the requested and supplemental content pieces are served in pay per consumption model, free of any impediment.
      Yet another alternative way to measure motivation is to quantify how much personal/private data users are willing to provide to access a customized version of a high ranking page (i.e., a page that includes supplemental content).
   Activity indicators
      Traffic volume: How does it compare to the average volume?
      Average time spent: More time=higher TBR
      User Activities: More activities=higher TBR(ex: scroll, likes, shares, comments, etc.)
   Similarity indicators
      Similarity with other high TBR pages, measured in terms of the explicit and implicit features.

The foregoing is reflected in FIG. 1 by rectangles 46 representing a web page delivered to multiple client devices by server 12 in response to requests, represented by arrows 48, for that page generated by users of those respective client devices via browsers 32 executing thereon. It is also reflected in FIG. 2, which depicts a time-wise sequence of requests and transfers between those respective devices.

With continued reference to FIG. 1, at some prior time period, application 30 executing on server 30 transferred to client devices 18, 24 customizations 46a, 46b of the web page 46 in response to requests 48a, 48b generated by applications 32 executing on those client devices. See also, the sequence of requests and responses between devices 12, 18 and 24 reflected in connection with the period labelled “Earlier Time Period” in FIG. 2.

As discussed further below, it is in connection with delivery of that customized web page 46 (to wit, customizations 46a, 46b) to those devices 18, 24 that application 30 determines in part TBR values for that page 46 and its customizations, e.g., based on the responses of those users to the customized pages and their respective contents and/or on those users actions once granted access to the pages. See also, the final action depicted for device 12 in connection with the period labelled “Earlier Time Period” in FIG. 2.

Once those TBR values are determined, the application 30 delivers a customized version of the page—here, designated 48c and shaded for emphasis—to device 16 in response to a subsequent request for that page by the user of that device. See also, the sequence of requests and responses between devices 12 and 16 in connection with the period labelled “Subsequent Time Period” in FIG. 2.

In some embodiments, the application 30 delivers customized versions of a requested page, e.g., web page 46, based not on a TBR value, in combination with implicit and explicit features, determined from prior accesses to (or attempts to access) that page and its customizations but, rather, based on prior accesses to (or attempts to access) other pages—or, more simply put, the TBR value of other (typically, similar) pages can be used as a TBR value for a requested page. An appreciation of this as applied in some embodiments of the invention may be attained from the following note:
MEASURING PAGE SIMILARITY
   The application 30 is in a position to assign a quality score to a page, e.g., 46, by finding the most similar pages in its universe and interpreting the amount of utility value it can generate for the user, publisher and/or advertiser
   Various (unsupervised or semi-supervised) machine learning approaches may be employed to infer implicit features from explicit features and determine similarity; methods include k-nearest neighbor, clustering, deep and shallow neural nets, principal component analysis, etc.
   Particularly useful for pages that are yet to be published or pages that do not have enough activity data available

### Use Cases

As those skilled in the art will appreciate, the higher the TBR value of a given web page (or other piece of digital content), the more engaging (e.g., interesting) that page is likely to be to that user; the lower that value, the less engaging it is likely to be. The application 30 can capitalize on that in a number of ways.

For example, since a higher TBR value suggests that the page is more engaging to the user, it also suggests that the web page is (or should be) more valuable to the publisher, advertisers and other stakeholders (e.g., authors, artists, creators, etc., whose content appears on the page). Accordingly, in some embodiments, the application 30 notifies accounting logic 50 (executing on device 12 and integral with application 30, or otherwise) of the identity of each delivered web page along with its TBR value (if the page has one) for use by that logic 50 in debiting or crediting respective stakeholders' accounts. For example, when the application 30 delivers a web page having a TBR value of 10 to application 32 executing on device 16 in response to a request by a user of that device, the application 30 can duly notify accounting logic 50, which debits by $10 the account of each advertisers whose ad content appears on that page and credits $5 to the web page publisher and $5 to the pool of authors/artists whose content appears on that page. Conversely, to continue the example, when the application delivers a web page of TBR value 20 to the application 32, it can duly notify accounting logic 50, which doubles both the amounts debited and credited to those respective parties.

Other embodiments capitalize on the TBR value in other ways, instead or in addition to the foregoing. Since TBR value can serve as an estimate of how engaging a page is to users, the application 30 can customize web pages that have high TBR values by supplementing them with content before delivery to the requestor with advertisements, calls to action, appeals or other content whose value is maximized by additional user exposure. Conversely, the application 30 can decide not to customize pages with low TBR values or customize them with supplements that require less attention for impact.

Continuing the above examples, when the application 30 delivers a web page having a TBR value of 20 to application 32 executing on device 16 in response to a request by a user of that device, the application 30 utilizes customization logic 52 (executing on device 12 and integral with application 30, or otherwise) to customize that page before delivery by inserting a somber appeal for donations to a relief fund or material more likely to be ignored by that user unless she spends a considerable time perusing the other content of the requested page. In some embodiments, upon delivery of the customized page, the application notifies the accounting logic 50 of the page identity, the TBR value and the identity of any digital content (e.g., advertisements, etc.) provided on account of the customization.

Conversely, to continue the example, when the application 30 delivers a web page having a TBR value of 10 to application 32 executing on device 16 in response to a request by a user (possibly with a significant TBR computed also for the user) of that device, the application 30 utilizes logic 52 to customize that page by inserting an eye-catching ad (with high enough ad TBR value, or ACDR, as discussed below) that is likely to draw attention from that user even if she only briefly peruses the page's other content. Again, upon delivery of the customized page, the application 30 can notify the accounting logic 50 of the page identity, the TBR value and the identity of any digital content (e.g., advertisements, etc.) provided on account of the customization. Logic 52 can generate the customized web page by manipulation of the HTML, Flash, embedded links or other codes defining that page in order to insert, remove, reposition or otherwise modify the page to effect the desired customization.

Note that by utilization of the foregoing methodology (particularly, for example' in view of the discussion below) and by the repeated customizations, one expects to slowly evolve the entire eco-system of users, contents and ads to a better and more pleasant state: high ranked users (whose only characteristics relevant for ad-decisioning are known to the system while respecting user's privacy) visit high ranked personalized pages while only interrupted by high ranked informative and useful ads.

In some embodiments, such customization of content can include varying hypertext or other links on requested web pages depending on their respective TBR values. In this way, customization can alter a sequencing of web pages delivered by the server application 30 to the client applications 32. For example, when the application 30 delivers a web page having a high TBR value to application 32 executing on device 16 in response to a request by a user of that device, the application 30 utilizes logic 52 to customize that page by inserting links to still other web pages of high TBR value, which pages can, themselves, include links to yet still other web pages of high TBR value (and so forth and so on), terminating in web pages that request donations, subscriptions or otherwise contain content of interest to highly engaged users.

A further appreciation of the use of TBR values in web page customization may be appreciated from the following note:
AD DECISIONING
By utilizing TBR scores in connection with ad placement on customized pages for a specific user, the application 30 allows for effecting the following in real-time
   Optimum ad-targeting
      which pages to target for video advertisement for better KPI's
      which pages to not place ads on to reduce abandonment
      which ads generate maximum revenue without affecting loyalty of high-valued users
   Optimum ad length prediction
      optimum length of advertisement to run on the page
   Optimum ad-type prediction
      whether page performs better with click-to-play or autoplay ad or possibly non-video ad (ie: display, rich media or other).

### Content Customization Based on Implicit Characteristic Determination

Described above are embodiments in which web pages (or other pieces of digital content) requested by a user are customized using implicit and explicit characteristics associated with tensor based rank (TBR), an estimate of the KPI's that can be derived from the manner in which a given user engages with a web page or other content piece—or, more simply put, the estimated appeal of the requested content. As discussed below, similar and simultaneously computed, are TBR's for the users and ads, which estimate the value of a user and effectiveness of an ad, respectively.

Systems according to the current invention differ from the CAR-related approaches of the aforementioned incorporated-by-reference application in that those of the current invention employ a tensor-based algorithm to compute implicit features of pages, advertisements and users, which in combination of additional explicit features guide the customization process. Additionally, systems of the current invention allows computation of various rankings which can be used in improving KPI's, pricing advertisements, identifying potential subscribers, etc. These rankings may be shared with other stake-holders in a “market” to improve market efficiency. Put another way, systems according to the present invention operate, at least in part, by determining the rank or ordering of pages, advertisements and users w.r.t. a given KPI. The system employs tensor factorization on implicit features (that are estimated/computed from explicit features) to derive that ranking. One of the differences over CAR is this ranking applies to users and advertisement as well, unlike ranking of just pages.

Systems according to the current invention differ from the CAR-related approaches of the aforementioned incorporated-by-reference application in still other ways, as well. Unlike CAR-related approaches that provide a unified score or a single ranking, in systems according to the present invention multiple rankings can be constructed based on different tensors, each constructed based on a separate KPI. For example, separate tensors can be built to measure publisher KPI like retention rate and advertiser KPI like view completion rate, and pages or the supplemented content can be ranked in descending order of user retention, or ascending order of view completion.

Another difference between systems according to the present invention and CAR-related approaches is that in systems according to the present invention rank can be computed for user, supplemented content or requested content based on either implicit features, or explicit features, since there exists a mapping between implicit and explicit features. That facilitates building a predicted rank of a new entity (e.g., a user, a piece of supplemental content or a requested page) based on its explicit features.

The embodiments described below provide still further advances in the art of digital content delivery and customization. In those embodiments application 30 (and, more generally, server 12) customizes requested content pieces as a function of a Page Customization Decisioning Rank (PCDR) (which is a TBR associated with the requested piece) based, at least in part, on one or more implicit or explicit characteristics of any of (i) a selected piece (or type) of digital content requested by the user, (ii) supplemental digital content with which that selected piece (or type) can be combined (or by which it can be supplanted), (iii) the user requesting the digital content, (iv) the digital data device via which the user makes the request, and (v) a combination of one or more of the foregoing. Those implicit characteristics are determined from factorization of a tensor reflecting one or more explicit (i.e., measured) user interaction data pertaining to any of items (i)-(v). The implicit characteristics are further augmented with explicit characteristics, known by direct measurements, and can be modified to improve the ranking. Examples of such explicit characteristics could be length of the page, words used in the title, number of images associated with the page, background materials and references to related pages, etc. In a symmetric manner, there are TBR's associated with ads (or other supplemental content) referred to as Ad Customization Decisioning Rank (ACDR) and TBR's associated with users referred to as User Customizing Decisioning Rank (UCDR) that play similar roles with respect to the other dimensions in the tensor.

Thus, whereas the CAR estimates the appeal of only a requested web page or other content piece, the PCDR, ACDR and UCDR (i.e., the TBR's of systems of the present invention) are additional technological advances that can be used, among other ways, to rank not just requested web pages but also to rank users, the user's digital data devices, ads and other supplemental content pieces, and/or a combination of the foregoing, among other things, based at least in part on their projected, estimated, inferred or otherwise implicit characteristics. And, by using such a TBR (Tensor Based Rank), the application 30 can customize content for delivery to a user via his/her device 14-24

And, while the CAR value can be focused on segments of the user population (e.g., users of a given gender or other demographic) by application of various controls, e.g., based on browser cookies, browser search history, request-originating IP address or otherwise, PCDR does not require such control but, rather, inherently provides multivariate segmentation down to the level of the user depending on the nature of the measured, explicit characteristics and the implicit characteristic inferred therefrom.

The foregoing is reflected in FIG. 1 in which, as discussed above, rectangles 46a, 46b, 46c represent content (e.g., a web page, variations thereof and/or other content) delivered to client devices by server 12 in response to requests, represented by arrows 48, generated by user(s) of those respective device(s) via browsers 32 (or other requesting applications) executing thereon.

The foregoing is also reflected in FIG. 2, which depicts a time-wise sequence of requests and transfers between those respective devices. As discussed elsewhere herein, although these figures and the accompanying text use web pages as examples, the teachings hereof are equally applicable in responding to request for other types of digital content.

### Explicit Characterization of Users, User Devices and Content

In step 100, the application 30 collects characteristics about user devices 12-18, their respective users, and content pieces that may be requested by those users (via those client devices) and content pieces that may be used to supplement (and customize) requested content pieces The application collects those characteristics in order to build for each of them an explicit characteristic tensor for use in determining implicit characteristics of the users, their devices, requested content, supplemental content and/or combinations of the foregoing.

In the illustrated embodiment, which is utilized for the purpose of supplementing requested content pieces (such as news articles, magazine stories, instructional videos, or other content pieces) requested by the users of the devices 14-24 with advertisements, calls to action, appeals or other supplemental content, the application 30 collects one or more of the following explicit characteristics regarding user devices 14-24, e.g. operating system, device type(mobile/desktop), name and version information of the browser or application requesting content and their respective users: e.g., gender, age, hobbies, recent topics of interest, etc. The device characteristics are often embedded in the request and can be stored while fulfilling the request. The user characteristics may be collected by one or more the following techniques:
Prompting users to enter personal information prior to, in connection with, or subsequent to requesting a particular web page (or other piece or type of content). This can be incentivized by alerting user that if he/she provides sufficient information to attain “elite” or other status, he or she will be awarded bonus content or other awards.
Inferring the explicit features from the implicit features, which would have been calculated by tensor factorization, and asking the user to confirm. Inference is carried out by such (supervised or semi-supervised) machine learning algorithms as k-nearest neighbor, clustering, PCA analysis, shallow and deep neural nets, etc.
Obtaining them from other sources such as DMP (data management platform) or a social network that a user belongs to.

Of course, other embodiments whether utilized for the same or other purposes may collect these and/or other explicit characteristics about users and/or other respective devices in other ways. In addition, a small group of loyal “elite” users may be rewarded to provide private information subject to suitable informed consent; the “elite” users may be selected so that they represent various stratification of the entire user population. The data from the “elite” users may be used to impute or infer (using machine learning algorithms) the explicit characteristics of non-elite users.

Continuing with discussion of step 100 and an embodiment purposed for supplementing requested content with advertisements, the application 30 collects one or more of the following explicit characteristics regarding web pages and other digital content pieces that may be requested by users of devices 14-24: keywords, length, style, number of hyper-links, number of references, number of images, videos, boxes, tables, etc. These characteristics may be collected from store 12a or other sources of requested content pieces by one or more the following techniques: by directly contacting the content providers, by inference using machine learning, or from third party statistics such as “likes,” reviews, comments, etc. Of course, other embodiments whether utilized for the same or other purposes may collect these and/or other explicit characteristics about web pages or other requested content in other ways. Other avenues discerning explicit characteristics of such content are by conducted A/B testing carried on using a random sampling of the “elite” users.

Further continuing with discussion of step 100 and an embodiment purposed for supplementing requested content with advertisements, the application 30 collects one or more of the following explicit characteristics regarding advertisements or other content pieces that may be used to supplement (and thereby customize) requested content pieces includes: viewability, ad-length, ad-skip-length, types of ad (banner, video, etc.), targeted groups, purpose (e.g., advancing users along various informational states in a funnel, etc.), and so on. These characteristics may be collected from store 12b or other sources of supplemental content pieces by one or more the following techniques: by directly requiring the advertisers to provide this information, by inference using machine learning, or by user surveys. Of course, other embodiments whether utilized for the same or other purposes may collect these and/or other explicit characteristics about users and/or other respective devices in other ways. Other explicit characteristics may be determined by A/B testing carried on using a random sampling of the “elite” users.

In step 102, the application 30 constructs an explicit characteristics tensor T from characteristics collected in step 100. In the illustrated embodiment, the tensor comprises a three-dimensional tensor (e.g., a 3D data cube), here, referred to as T, where explicit characteristics of a user using a user device (e.g., 14-24), a content piece and a piece of supplemental content are represented by a data tuple Tᵢⱼₖ, a unique combination of (Uᵢ, Pⱼ, Cₖ). Each entry of such a tensor, as indexed by Uᵢ, (1≦i≦l), Pⱼ (1≦j≦m), Cₖ (1≦k≦n), where Uᵢ represents users of devices 14-24, Pⱼ represents explicit characteristics of individual content pieces that may be requested by those users (e.g., as contained in store 12a or otherwise), and Cₖ represents explicit characteristics of individual content pieces that may be used to supplement the requested pieces (e.g., as contained in store 12b or otherwise). Each entry of the tensor represents a characteristic statistic, e.g., session length or abandonment rate, etc. In the illustrated embodiment, a majority of the entries of the tensor are missing (and labelled, for example, “⊥” or otherwise). Such a tensor may be constructed by the following technique: primarily using data science algorithms that create large historical data-bases to be further data-mined, but also by various statistical inference techniques.

Thus, by way of non limiting example, in the illustrated embodiment, every user interaction data on client devices, e.g. 18, is sent back along with explicit features about the user, device, and content in the form of a pixel data to application 30, that collects and orders all the interaction data using a distributed messaging system like Apache Kafka or otherwise (e.g., as adapted in accord with the teachings hereof). In near real-time, event level information is aggregated and various statistical inferencing techniques are applied to aggregate data using data stream processing technology like Apache Storm or otherwise (e.g., as adapted in accord with the teachings hereof), and pushed to be stored on a distributed data storage system like Hbase or otherwise (e.g., as adapted in accord with the teachings hereof). The tensors are constructed periodically by retrieving explicit features and aggregate interaction data from Hbase, computing the characteristic statistics for each tuple whenever available, and applying map-reduce to calculate the implicit features in the form of a linear/non-linear combination of the explicit features. Then a tensor factorization algorithm is applied using map-reduce to estimate the missing values.

Of course, those skilled in the art will appreciate that the tensor T may be constructed in other ways in view of the teachings hereof. Although tensors are used in the illustrated embodiment, those skilled in the art will appreciate that other constructs in the general nature of machine learning algorithm that extract features and hierarchy of meta-features maybe used instead or in addition in general accord with the teachings hereof. An example of such a process may be built upon deep neural network or manifold learning methods.

In steps 104-118, the application 30 continues to collect characteristics of the type referred to in connection with step 100, albeit, with focus on characteristics pertaining to the interactions between users (and, implicitly, their respective user devices) and web pages (and their substituent content pieces including advertisements) transmitted to those users by application 30 (and, more generally, by server 12) in response to user requests.

Thus, for example, in step 104, application 30 receives a request for a web page from one of the client devices, e.g., 18. This can be in the form of an HTTP request that specifies the page by URL or otherwise. For this and other types of digital content the request may utilize another protocol, proprietary or otherwise.

In step 106, the application 30 retrieves the requested content from store 12a (or otherwise), optionally supplementing it with content from store 12b (or otherwise) utilizing the techniques described below in connection with steps 124-126 (or otherwise), and delivers the requested page 46a (including the requested content and any supplemental content) to the requesting user's device 18.

In step 108, the application 30 monitors and logs the response of the user of the requesting device (e.g., device 18) to the delivered page 46a. In the illustrated embodiment, the focus of this monitoring and logging is to collect characteristics pertaining to interactions between the requesting user (and/or his respective device 18) and the content pieces making up the delivered page 46a. In an embodiment such as that illustrated here purposed for supplementing requested content with advertisements, collected characteristics include such user characteristics as gender, age, hobbies, etc., such content characteristics as length, style, number of references, etc., and such ad characteristics as viewability, length, and skip-time, etc. The above-mentioned characteristics may be collected by one or more the following techniques: direct collection, machine learning-based inference or experimentation using a subsample of “elite” users. Other embodiments whether utilized for the same or other purposes may collect these and/or other explicit characteristics about users and/or other respective devices in other ways, for example those described earlier.

In step, 110, the application 30 updates the explicit characteristics tensor T via the following techniques, though in other embodiments it can be updated in other ways as will be evident to those skilled in the art: For instance, after each session, the session length and abandonment rates may be updated in the tensor and tensors are re-factorized to update the implicit features and their association with the explicit features.

Steps 112-118 parallel steps 104-110, albeit, with respect to page 46b requested by device 24.

In step 120, the application 30 generates a set of implicit characteristics for the pages, users and ads for a tensor T′ᵢⱼₖ from the input sparse tensor Tᵢⱼₖ. While the explicit characteristics are collected directly from the users, publishers or ad agencies directly, as discussed above (e.g., by machine learning algorithms, or by a set of “elite” users, by customization of contents and ads, etc.), the implicit characteristics are indirectly derived from the interaction of the user with contents and ads through factorization of appropriate explicit tensors. Implicit characteristics can be thought of approximately characterizing a user, a content piece and an ad (i.e., supplemental content piece) in the following sense: by tensor product of the implicit characteristics, one should be able to recreate the tensor entries completely, while minimizing the error in how well this process approximates the labeled entries. The sizes of the implicit characteristics vector is selected by the algorithm, or by a human expert in such a way the error of underfitting and overfitting is kept minimal. A cross-validation process, assessing underfit and overfit, is used to select the most optimal hyper-parameters (e.g., sizes) of the implicit characteristics. Further optimization may be carried out to ensure concordance between implicit and explicit characteristics.

Put another way, these implicit characteristics are characteristics that are estimated, projected or otherwise inferred from the measured characteristics (or statistics) in the tensor T. Examples of estimation of such hidden characteristics in the illustrated embodiment purposed for supplementing requested content with advertisements, occur when the tensor entries are session length and/or abandonment. Such a tensor T′ᵢⱼₖ may be constructed by the following technique: Tensor factorization algorithms have been known in mathematical literature and can be carried out in a preferred embodiment using CPD (Canonical Polyadic Decomposition), for instance; Other methods include tensor decomposition via Tucker factorization, Khatri-Rao factorization, etc. As described earlier, low-rank approximation of the tensors, which is determined by the sizes of the implicit characteristics vectors, may be based on cross-validation, heuristic or computational resource availability. Of course, those skilled in the art will appreciate that the tensor T′ may be constructed in other ways in view of the teachings hereof.

Thus, the computed implicit characteristics are used to estimate the missing entries in the input sparse tensor and thus create a complete estimated tensor (which best approximates the filled entries of the input tensors). Such a complete input tensor may not be stored explicitly as the computational storage demand may become exorbitant, and since the estimated entries can be computed on-the-fly from the implicit characteristics, as needed.

Next, the implicit features are combined with and associated to other explicit features obtained directly (or by machine learning or from subsampling/experiments, etc.), as described earlier.

For a web page, a rank (PCDR) can be computed by taking a slice of the estimated full tensor, as the slice indicates how each user responded to the page (e.g., in terms of session length and abandonment) in the presence of various ads. A page that generates longer session length and less abandonment will more likely receive a better score, and a higher PCDR. The score function used may be a function of the variables, corresponding to the tensors (e.g., session length and abandonment), where the score function may be inferred (e.g., by linear or non-linear regression) to optimize a utility, such as the revenue earned, the size of the user population, or KPI's of choice. In other words, a page will have a higher rank, if it contributes to a higher KPI or revenue, etc. Each such KPI can be mathematically represented as a high-dimensional tensor with an entry for a specific combination of a user, a content and a page, though not every such entry may be known a priori; such missing entries may be statistically imputed using efficient algorithms such as the ones exemplified by a preferred embodiment of the current invention.

In some embodiments, the slice(a segment of data relevant to the content) used to compute the rank from the estimated tensor may be further re-weighted or restricted: for instance, in the slice, higher ranked users and ads may be given higher weight, or the slice used is restricted by implicit or explicit features, such as only adult male users, who have been served sports-related ads. The implicit and explicit features are used in computing the TBR's for each category and subsequently used to customize and improve the respective ranks.

In steps 122-128, the application 30 utilizes implicit and explicit characteristics reflected in the tensors to customize a webpage requested by the user of device 16. Though in the illustrated embodiment, the implicit characteristics are those computed from the sparse input tensor and of candidate web page customizations and their potential appeal to a specific requesting user, in other embodiments they may reflect characteristics of one or more entities on which explicit characteristics were collected, e.g., characteristics of the requesting user, his/her device 14-24, the requested web page, a candidate supplemental piece of content (e.g., an advertisement) or combinations of the foregoing.

Thus, for example, in step 122, application 30 receives a request for a web page from one of the client devices, e.g., 18. This can be in the form of an HTTP request that specifies the page by URL or otherwise. For this and other types of digital content the request may utilize another protocol, proprietary or otherwise.

In step 124, the application 30 determines the TBR's of each of the requested content piece and candidate supplemental content pieces, as determined by the explicit and implicit characteristics obtained by tensor factorization. In the embodiment purposed for supplementing requested content with an advertisement, this is performed by rank order of the ads described by the scores in the fibre of the estimated tensor. Of course, in other embodiments, whether like-purposed or otherwise, TBR may be determined in other ways in view of the teachings hereof.

In step 126, the application 30 creates a webpage 46c from the content requested by the user, as combined with a supplemental content piece selected in accord with the TBR and scores. This can be accomplished by scores computed from the appropriate slices of the estimated tensors

In step 128, the application 30 delivers the supplemented page 46c to the requesting user's device 12 and, in step 130, monitors and logs the results as discussed above in connection with step 108. In step 132, the application updates the input tensors, to be further processed to improve the implicit characteristics and re-mapped to the explicit features as discussed above in connection with step 110. It can, concurrently, calculate the hidden characteristics, e.g., as discussed above in connection with step 120, and update the implicit characteristics of users, pages and ads accordingly.

### Discussion

A fuller understanding of the TBR may be obtained by reference to FIG. 1. As discussed above in connection with steps 104-114, in response to requests 48a, 48b generated by applications 32 executing on client devices 18, 24, application 30 executing on server 30 transfers web pages 46a, 46b to applications 32 executing on those devices. The web pages 46a, 46b may constitute the particular pieces of content requested by the respective devices, possibly, supplemented with supplemental content pieces. See the discussion above in connection with Step 106. In fact, in some instances, the application can wholly or partially supplant (i.e., replace) the requested content pieces with a supplemental content piece. Instances of the foregoing may be appreciated by the following examples.

For example, depending on the requests 48a, 48b generated by the client devices, the delivered web pages 46a, 46b may include common content, e.g., a common news article, magazine story, instructional video, or other content piece requested by the users of the requesting devices. In the illustrated embodiment, those content pieces can be sourced by application 30 from store 12a or otherwise.

Pages 46a, 46b can, as noted, also represent variations of that content, e.g., supplemented with varied advertisements, calls to action, appeals or other content, sourced by application 30 from store 12b or otherwise. For example, pages 46a and 46b may both comprise a news article on a political campaign, one supplemented with an auto advertisement (e.g., page 46a) and the other supplemented with a fashion advertisement (e.g., page 46b); or, by way of further example, one of the pages (e.g., page 46a) may contain only the news article and the other (page 46b) may additionally include one of the aforesaid advertisements.

By way of further example, pages 46a, 46b may comprise entirely disparate content, instead. For example, page 46a may comprise the aforementioned news article supplemented with the aforementioned auto ad, while page 46b may comprise an infomercial supplemented by the aforementioned fashion ad. Still further, pages 46a, 46b may comprise differing underlying content (one, the aforementioned news article; the other, the aforementioned infomercial), yet both may be supplemented by the same supplemental content piece, the aforementioned fashion ad. Still further, one or both of pages 46a, 46b may comprise supplemental content alone, e.g., the auto advertisement and/or the fashion advertisement continuing the above-example, without any news article, magazine story or other requested, substantive content.

As used above and elsewhere herein, unless otherwise evident from context, the terms “supplemental content,” “supplemental content pieces,” and the like refer to content (sourced from store 12b or otherwise) that supplements content requested by a user device 14-24. Conversely, the terms “requested content,” “substantive content,” or the like, refer to content (sourced from store 12a or otherwise) that is the focus of a user request.

As discussed further below, it is at least in part in connection with delivery of pages 46a, 46b to those devices 18, 24 that application 30 collects measured characteristics regarding the content included in those pages—regardless of whether the included content was that originally requested by users of devices 18, 24 (e.g., news articles), whether it was supplemental content added to the requested content (e.g., advertisement), or otherwise. See the discussion above, e.g., in connection with Step 108.

It is from those measured characteristics that application 30 relates to implicit characteristics of that content. See the discussion above in connection with Step 102. In response to a request 48c from device 16, the application 30 determines from those implicit characteristics and for the user of that particular device, the TBR of pages that could be constructed from various combinations of user-requested content pieces and the supplemental candidate content pieces. See the discussion above in connection with Step 124. Based on that ranking, the application constructs a page 48c and transmits it to the requesting device. See the discussion above in connection with step 128. Application 30 can monitor the actions of the user of device 16 to that page 48c and update the tensors accordingly. See the discussion above in connection with Steps 130, 132.

### Use Cases

Depending on specific combinations of explicit and/or implicit characteristics on which they are based, the TBR ranking provides a relative quantitative (or qualitative) estimate of differing responses to or values of pages customized based on that TBR ranking. For example, a TBR that is based on explicit characteristics such as gender and implicit characteristics such as the second element of the feature vector as computed by tensor decomposition can serve to quantitatively (or qualitatively) estimate the relative amounts of time a given user of a known gender is likely to spend on a page in presence of several different supplemental content pieces like advertisements. In this regard, as will be appreciated by those skilled in the art, tensor factorization will create a vector of implicit features (each of size k) for the user, page and ad. Such a feature vector is like an eigenvector and has first, second, . . . kth elements. These are like principal components and have no direct interpretation, but must be some combination of explicit features like age, gender, etc. The implicit features can be a linear/non-linear combination of explicit features, hence not having any human comprehendible meaning or definition attached to them. By transmitting to the user a page comprising the requested content piece supplemented by the supplemental content piece returning the highest TBR value, the application 30 better insures that the user is likely to linger on that page the longest.

On the other hand, by way of example, a TBR that is based on explicit characteristics such as interest set (auto enthusiast, frequent traveler, etc.) and implicit characteristics such as its second element can serve to quantitatively (or qualitatively) estimate the relative likelihood that a user will respond to various calls to action that might be used to supplement a requested content piece. By transmitting to the user a page comprising the requested content piece supplemented by the supplemental content piece returning the highest TBR value of this type, the application 30 better insures that the user is likely to act on the supplemental call to action.

Indeed, a TBR that is based on explicit characteristics such as gender and implicit characteristics such as its second element can serve to quantitatively (or qualitatively) estimate the relative degree of engagement a given user is likely to feel to a requested content piece and any of several different supplemental content pieces. Like the CAR (Content Appeal Rank) value, a higher TBR value of this type suggests that the page is more engaging to the user, it also suggests that the web page is (or should be) more valuable to the publisher and other stakeholders (e.g., authors, artists, creators, advertisers, etc., whose content appears on the page).

Other embodiments capitalize on the TBR value in other ways, instead or in addition to the foregoing. For example, a TBR that is based on explicit characteristics such as “elite” user status and subset of implicit characteristics such as those suggesting educational level (assuming that is not a measured characteristic) can serve to quantitatively (or qualitatively) estimate the relative complexity of supplemental content the user can understand (and, if desired/desirable, respond to) when combined with a requested content piece. By way of further example, a TBR that is based on explicit demographic characteristics and well as inferred, implicit user demographics—e.g., as where the user has provided his/her user age but where gender must be inferred—can serve to quantitatively (or qualitatively) estimate the user's relative interest types of advertising provided as supplemental content to a requested piece.

By way of further example, by calculating multiple different TBR rankings in response to a user request for a given page, the application 30 can select values among the various TBR rankings in choosing an optimal combination of requested supplemental content to deliver to that user. For example, if one set of PCDR rankings is indicative of the page engagement and another is indicative of abandonment, the application can choose to select among values of the first ranking in instances where engagement is priority, and to select among values of the second ranking in instances where user retention is priority. As a result, the application is able to suggest different, personalized customization schemes based on fundamental selection criteria for web page customization. In other words, the system can recommend different ranking and provide different delivery of content based on the desired KPI. Advertisers prioritize interaction with the unit, publishers prefers user retention, and separate tensors can be built for each such goal. Here, and in the other examples above, logic 52 can generate the customized web page by manipulation of the HTML, Flash, embedded links or other codes defining that page in order to insert, remove, reposition or otherwise modify the page to effect the desired customization.

In some embodiments, such customization of content can include varying hypertext or other links on requested web pages depending on their respective TBR values. In this way, customization can alter a sequencing of web pages delivered by the server application 30 to the client applications 32. For example, when the application 30 delivers a customized web page having a high TBR value to application 32 executing on device 16 in response to a request by a user of that device, the application 30 utilizes logic 52 to customize that page by inserting links to still other customized web pages of high TBR value, which pages can, themselves, include links to yet still other customized web pages of high TBR value (and so forth and so on), terminating in web pages that request donations, subscriptions or otherwise contain content of interest to highly engaged users.

A further appreciation of the use of TBR values in web page customization may be appreciated from the following note:
Target Audience Detection
For a given piece of supplemented content, based on TBR of user groups or UCDR measured in terms of KPI time spent watching the supplemented content, identify the most appropriate audience for the content. Example, if an advertisement for a product was watched to completion more consistently and predominantly by users coming from north-eastern states of United States than users from other parts of the country, the product has a better chance of selling in those states than the rest of the country, providing valuable marketing and inventory management guideline to a nationwide retailer.
Campaign Creative Selection
If a promotional campaign targeted for a certain audience group is trying to decide between multiple creatives the most popular one, they can launch all the creatives and based on TBR of each campaign for the given user group or ACDR, decide the campaign to go with. Example business case could be a beverage manufacturer trying to launch a new flavor of beverage targeted for younger audience (Age group 18-35). It creates three different marketing campaigns, calculates their ACDR based on a trial run for a week for audience of that age group, and picks the top-ranking campaign as their final nation-wide campaign to launch the new beverage.

Similar improvements to customization of the user rank values or advertisement rank values would be apparent to a person having ordinary skill in the art, and are incorporated in the current invention.

Other improvements involving additional interactions, for instance, an event combining interactions of user, device technology (i.e., laptop, phone or virtual reality platform), content and advertisement, which would result in a four- (or higher) dimensional tensor data structures and an extension of the customization process, would also be apparent to a person having ordinary skill in the art, and are also incorporated in the current invention.

### CONCLUSION

Described above and shown in the drawings are methods and systems meeting the aforementioned and other objects. It will be appreciated that the embodiments shown here, however, are merely examples of the invention and that other embodiments incorporating changes therein may fall within the scope thereof.

In view of the foregoing, what is claimed is:

1. A digital data system for automated customization of digital content delivered over a network, comprising
A. a server digital data device that is coupled to and in communications coupling with a plurality of client digital data devices over the network,
B. the digital data device responding to requests received from the client digital data devices at the behest of users thereof for delivering to those respective client digital data devices requested digital content, and
C. the server digital data device that customizes at least a selected piece of digital content that it delivers to a said requesting digital data device in response to a said request received from that device based on a rank of projected appeal or other projected characteristic of the customized piece of digital content to a user of that client digital data device, where that rank is based on one or more implicit characteristics of any of
the user of the requesting digital data device,
the client digital data device from which the request was received,
the selected piece of digital content,
supplemental digital content with which that selected piece is combined to provide such customization,
interactions between the user and the customized piece of digital content on the client digital data device from which the request was received.
where the server digital data device determines those one or more implicit characteristics by factorization of a tensor reflecting of on one or more explicit characteristics of any of
the user of the requesting digital data device,
the client digital data device from which the request was received,
the selected piece of digital content,
supplemental digital content with which that selected piece is combined to provide such customization.
interactions between the user and the customized piece of digital content on the client digital data device from which the request was received.

2. The digital data system of claim 1, in which the network comprises an Internet and the digital content comprises one or more web pages.

3. The digital data system of claim 1, in which the selected piece of digital content is a web page or other piece of digital content and where the server digital data device customizes the web page or other piece of digital content by supplementing it with one or more advertisements, calls to action, appeals or other content before delivering that web page or other piece of digital content to a requesting client digital data device.

4. The digital data system of claim 1 in which the server digital data device utilizes, as the implicit characteristic(s) upon which the rank is based, those reflecting the projected appeal to the user of the requesting client digital data device of the selected piece of digital content in combination with a particular piece of supplemental content.

5. The digital data system of claim 4, in which the server digital data device utilizes, as the implicit characteristic(s) upon which the rank is based, those reflecting the projected appeal to the user of the requesting client digital data device of the selected piece of digital content in combination with the particular piece of supplemental content as viewed by that user on that client digital data device.

6. The digital data system of claim 1 in which the server digital data device utilizes, as the implicit characteristic(s) upon which the rank is based, those reflecting the projected appeal to the user of the requesting client digital data device of a piece of the type of the selected piece of digital content in combination with a piece of the type of the particular piece of supplemental content.

7. The digital data system of claim 1, in which the server digital data device utilizes, as the implicit characteristic(s) upon which the rank is based, those reflecting the projected appeal to the user of the particular piece of supplemental content regardless of whether it is delivered to the requesting client digital data device in combination the selected piece of digital content.

8. The digital data system of claim 1, in which the server digital data device collects characteristics about one or more of the user of the requesting digital data device, the client digital data device from which the request was received, the selected piece of digital content, and the supplemental digital content with which that selected piece is combined to provide such customization and builds therefrom one or more explicit characteristic tensors for use in determining said implicit characteristics.

9. The digital data system of claim 8, in which the server digital data device collects characteristics about the user of the requesting digital data device by one or more of prompting the user to enter personal information, incentivizing the user to enter such information, prompting the user to confirm inferred characteristics, obtaining user information from a DMP (data management platform), a social network or other source.

10. The digital data system of claim 8, in which the server digital data device collects one or more of the following characteristics about the selected piece of digital content: keywords, length, style, number of hyper-links, number of references, number of images, videos, boxes, tables.

11. The digital data system of claim 8, in which the server digital data device collects one or more of the following characteristics about the particular piece of digital content: viewability, length, skip-length, type, targeted users, and purpose.

12. The digital data system of claim 1, in which the server digital data device constructs the tensor such that explicit characteristics of a user, client digital data device, selected content piece and particular content piece are represented by an indexed data tuple.

13. The digital data system of claim 12, in which the tensor is constructed from statistics of available tuples representing explicit characteristics of each combination of user, user device and digital content piece for which data has been collected, and in which implicit features are formed from linear/non-linear combinations those explicit characteristics, and in which a tensor factorization algorithm is applied to estimate missing values of a tensor of implicit and explicit features.

14. The digital data system of claim 8, in which, following delivery of the customized piece of digital content, the server digital data device collects characteristics pertaining to the interactions between the user and the customized piece of digital content on the client digital data device from which the request was received.

15. The digital data system of claim 14, in which the collected characteristics include any of session length and abandonment rates.

16. The digital data system of claim 15, in which the server digital data device updates the tensor to reflect characteristics pertaining to the interactions between the user and the customized piece of digital content.

17. The digital data system of claim 1, in which the server digital data device determines the implicit characteristics from the tensor by tensor factorization using any of CPD (Canonical Polyadic Decomposition), Tucker factorization, and Khatri-Rao factorization.

18. The digital data system of claim 17 in which the implicit characteristics are used to estimate the missing entries in the tensor and, thus, to create a complete estimated tensor.

19. A method of automated customization of digital content delivered over a network, comprising
A. responding to requests received from client digital data devices at the behest of users thereof by delivering to those respective client digital data devices requested digital content, and
B. customizing at least a selected piece of digital content delivered to a said requesting digital data device in response to a said request received from that device based on a rank of projected appeal or other projected characteristic of the customized piece of digital content to a user of that client digital data device, where that rank is based on one or more implicit characteristics of any of
the user of the requesting digital data device,
the client digital data device from which the request was received,
the selected piece of digital content,
supplemental digital content with which that selected piece is combined to provide such customization,
interactions between the user and the customized piece of digital content on the client digital data device from which the request was received.
where those one or more implicit characteristics are determined by factorization of a tensor reflecting of on one or more explicit characteristics of any of
the user of the requesting digital data device,
the client digital data device from which the request was received,
the selected piece of digital content,
supplemental digital content with which that selected piece is combined to provide such customization.
interactions between the user and the customized piece of digital content on the client digital data device from which the request was received.

20. A computer-readable medium on which are encoded, typically, instructions for carrying out a method of claim 19.
